(19) United States
(12) Patent Application Publication
(10) Pub. No.: US 2024/0269887 A1
(43) Pub. Date: Aug. 15, 2024

(54) SMOOTHING DEVICE AND METHOD FOR SMOOTHING A CONCRETE PART

(71) Applicant: AEDITIVE GMBH, Norderstedt (DE)

(72) Inventors: Hendrik LINDEMANN, Hamburg (DE); Anke LAUBER, Hamburg (DE); Stefan HAIN, Hamburg (DE); Roman GERBERS, Hamburg (DE)

(21) Appl. No.: 18/568,449

(22) PCT Filed: Jun. 22, 2022
(86) PCT No.: PCT/DE2022/100458

§ 371 Date: Dec. 8, 2023

(30) Foreign Application Priority Data
Jun. 24, 2021 (DE) 10 2021 116 332.3

(51) Int. Cl. B28B 11/08; B33Y 40/20; E04F 21/24

(52) U.S. Cl. CPC B28B 11/0845; B33Y 40/20; E04F 21/245

(57) ABSTRACT

The invention relates to a smoothing device (100, 200) for smoothing a structural concrete component (1), comprising a primary cutting edge (104, 204, 204′, 204″, 204′″) for separating a concrete layer from the structural concrete component, an axis of rotation (102, 202), and a smoothing surface (106, 206) aligned orthogonally to the axis of rotation (102, 202) for surface contacting of a cut surface of the structural concrete component (1) formed by the separation.

The invention relates to a smoothing device and a method for smoothing an uncured structural concrete component as well as a smoothing system.

Smoothing devices and corresponding methods are known in principle. In particular, additively produced structural concrete components do not essentially have a smoothing or flat surface due to the layer-based structure. In particular, when additive methods are used which have a large structural width, such as the shotcrete method, there is the problem that the desired component contour is only approximated. This is caused in particular by either too little or too much material being present at individual sections of the structural concrete component.

The production of structural concrete components using the shotcrete process is also characterized by the introduction of air pressure and by rebound effects, which means that the surface of the structural concrete component produced in such a way has a poor shape and dimensional accuracy and generally presents an unaesthetic surface appearance.

In order to produce high-quality structural concrete components, such produced concrete components are smoothed. When smoothing concrete, the coarse aggregates can break out on contact with a smoothing device, making it difficult or impossible to produce a uniformly smoothed surface. When smoothing three-dimensional components, it must also be taken into account that sharp-edged structures can only be produced at great expense, and these usually have to be reworked manually. In automated smoothing in particular, sharp-edged structures often break out or residual material remains on the edge or is smeared there.

One possibility for smoothing structural concrete components is to use manually guided smoothing devices, such as a trowel, a concrete trowel or a ride-on smoothing device. With these smoothing devices, the achievable surface finish of the smoothed structural concrete component depends on the skill of the operator. Furthermore, the application of these smoothing devices is essentially limited to flat surfaces.

The use of milling methods is generally limited to the processing of cured structural concrete components and results in the breaking out of aggregates, so that the surface quality to be produced is limited. Concrete reaming discs are configured for smoothing flat surfaces, with no or only limited influence on component dimensions. In addition, the processing speed is limited because high speeds lead to a high temperature input, which can result in an undesirable discoloration of the concrete surface. Furthermore, concrete trowels can be applied for smoothing. The surface finish produced with a concrete trowel does not meet high requirements. Furthermore, component dimensions cannot be influenced or can only be influenced to a limited extent, since only limited material can be removed with the concrete trowel.

It has been shown that the usual smoothing devices applied in the producing of structural concrete components are not suitable or only suitable to a limited extent for processing additively produced concrete components. In particular, they are not suitable or only suitable to a limited extent due to the break-out of aggregates and edges and the low material removal.

It is a requirement of the industry to manufacture structural concrete components automatically. In particular, the increasing individualization of structural concrete components requires the use of flexible methods. It is also a requirement that structural concrete components be produced automatically without the need for manual finishing.

It is therefore an object of the invention to provide a smoothing device and a method for smoothing a structural concrete component, as well as a smoothing system, which reduce or eliminate one or more of the disadvantages mentioned. In particular, it is an object of the invention to provide a solution that enables automated producing of structural concrete components.

This task is solved with a smoothing device and a method according to the features of the independent patent claims. Further advantageous embodiments of these aspects are indicated in the respective dependent patent claims. The features listed individually in the patent claims and the description can be combined with one another in any technologically useful manner, with further embodiments of the invention being indicated.

According to a first aspect, the problem is solved by a smoothing device for smoothing a structural concrete component, in particular an uncured structural concrete component, in particular an additively produced structural concrete component, preferably a structural concrete component produced by a shotcrete method, comprising a primary cutting edge for cutting off a concrete layer from the structural concrete component, an axis of rotation and a smoothing surface, which is oriented orthogonally to the axis of rotation, for two-dimensionally contacting a cut surface of the structural concrete component configured by the cutting off.

The invention is based, among other things, on the realization that only flat component surfaces can be smoothed with the known disc-shaped smoothing elements, and thus no effective smoothing of a three-dimensionally configured structural concrete component is possible. Due to the coarse concrete component structure close to the surface, smoothing by means of rotation and the known normal forces is not effective. The inventors have found that by cutting off a layer of concrete from the structural concrete component with the primary cutting edge and smoothing the cut surface essentially simultaneously with the smoothing surface, advantageous smoothing is made possible. The resulting surface is substantially unaffected by the coarse concrete component structure caused by the additive method. Furthermore, the quality of the surface is independent of the size of the applied aggregates, since these are either pressed into the concrete by the primary cutting edge or separated from the concrete.

The smoothing device has the primary cutting edge for separating the concrete layer from the structural concrete component. The primary cutting edge is arranged and configured to cut through concrete, particularly uncured concrete. An uncured concrete is particularly understood to be a concrete in which the hydration reactions of the binder have not been fully completed. Such a concrete may, for example, exhibit a tough material behavior. Furthermore, an uncured concrete may be understood to have only green strength. In such a state, the concrete is also referred to as green concrete.

The primary cutting edge may be configured to be sharp or blunt. A primary cutting edge angle of the primary cutting edge can be, for example, between 20° and 180″. The primary cutting edge is preferably arranged along a circumference of the smoothing device. For example, the primary cutting edge may have a circular contour orthogonal to the axis of rotation.

The smoothing device further comprises the axis of rotation. Preferably, the smoothing device is configured to be rotatable about the axis of rotation. Furthermore, it is preferred that the smoothing device is configured to be substantially rotationally symmetrical about the axis of rotation. Preferably, the primary cutting edge has a main extension direction oriented substantially orthogonal to the axis of rotation. The main extension direction of the primary cutting edge may also be configured in a curved shape, for example circular.

The smoothing device preferably extends in the direction of the axis of rotation from a proximal end to a distal end. In operation of the smoothing device, the distal end is in particular the end facing the structural concrete component to be processed. The proximal end is preferably the end of the smoothing device facing a handling device during operation.

The smoothing device further comprises the smoothing surface. The smoothing surface is preferably disposed at the distal end of the smoothing device. The smoothing surface is oriented orthogonally to the axis of rotation. In particular, this means that a smoothing surface orthogonal to the smoothing surface and the axis of rotation enclose a tilt angle that is smaller than 30°, smaller than 20°, smaller than 10°, smaller than 5°, smaller than 2°, smaller than 0.5°, and in particular 0°.

The smoothing surface is configured for flat contacting of the cut surface of the structural concrete component formed by cutting. When the smoothing device enters the structural concrete component and a concrete layer is cut off with the primary cutting edge, a cut surface is formed on the side of the structural concrete component on which the concrete layer has been cut off. The smoothing surface contacts this cut surface so that it is smoothed.

In a preferred embodiment of the smoothing device, the smoothing surface and the primary cutting edge are arranged and configured in such a way that, in a feed direction, the primary cutting edge first cuts off the concrete layer and then the smoothing surface contacts the cut surface. The feed direction is in particular the direction in which the smoothing device is moved along a processing path, for example with a straight movement. Such an arrangement of the primary cutting edge and the smoothing surface advantageously enables a surface of a structural concrete component to be produced with a high surface quality. In particular, advantageous surface properties are achieved by the prompt cutting and smoothing.

A further preferred embodiment of the smoothing device is characterized by the fact that the smoothing surface and the primary cutting edge are arranged on a smoothing body, the smoothing body preferably being configured in the shape of a circular ring and/or a wing.

In the case of a circular ring-shaped trowel body, it is preferred that the primary cutting edge is arranged on an outer circumference of the circular ring-shaped trowel body. Furthermore, in the case of a circular ring-shaped trowel body, it is preferred that the trowel surface is arranged on a flat side of the trowel body, in particular an underside. In the case of a wing-shaped trowel body, it is preferred that the primary cutting edge is arranged along an outer circumference of the wing-shaped trowel body. Preferably, the smoothing surface is arranged on a side, in particular an underside, of the smoothing body. The wing-shaped smoothing body is preferably configured with two, three, four or more wings. Circular and wing-shaped screeds have the advantage over closed screeds that less frictional energy is introduced into the structural concrete component and thus a better surface finish can be produced.

A preferred further development of the smoothing device is further characterized in that the primary cutting edge is configured on a front side of the smoothing device, in particular of the smoothing body, and is preferably configured by an inclination of the front side and/or of a front side section of the front side relative to the axis of rotation. A formation of the primary cutting edge on a front side also means that the primary cutting edge is configured as such by the front side.

The front side can have different, advantageous embodiments. For example, the end face may have a surface orthogonal that is oriented substantially orthogonal to the axis of rotation. In addition, the front side may be configured inclined to the axis of rotation. For example, it may be preferred that the surface orthogonal of the face and the axis of rotation form an angle of <90° when viewed from the smoothing surface so that aggregate is forced into the structural concrete component as the smoothing device is moved. Furthermore, it may be preferred that the angle mentioned in the foregoing is >90° so that aggregates are dislodged from the cutting surface in particular.

It is further preferred that the primary cutting edge is spaced from the smoothing surface in the direction of the axis of rotation. Spaced from the smoothing surface in the direction of the axis of rotation means in particular that the primary cutting edge is spaced from the distal end of the smoothing device a greater distance than the smoothing surface is spaced from the distal end, the smoothing surface preferably forming the distal end. Such an arrangement of the smoothing surface and the primary cutting edge advantageously affects the contacting of aggregates.

A further preferred embodiment of the smoothing device comprises a disposal section, preferably configured as a chip flute, which is arranged at least in sections between the primary cutting edge and the axis of rotation. A smoothing device with disposal sections has the advantage that the separated concrete layer can be advantageously removed from the structural concrete component, for example by means of secondary cutting edges.

A further preferred embodiment of the smoothing device comprises at least one lubricant feeder for feeding a lubricant to the smoothing surface. The lubricant may be, for example, water or concrete curing agent. Lubricant may be supplied to the smoothing surface through the lubricant supply, such that the surface quality may be further improved by the supply of lubricant.

The lubricant can be supplied with or without compressed air. The use of compressed air allows the lubricant to be atomized and thus small quantities can be applied in a targeted manner.

The lubricant improves the surface quality in particular by forming a lubricating layer of cement paste and lubricant, which on the one hand leads to a smoother surface and on the other hand brings about an improvement in the closing of defects or holes. In addition, the lubricant prevents excessive frictional heat from being generated and discoloring the surface of the structural concrete component. This also enables higher speeds and feeds and thus an improvement in productivity, as the time required for producing a structural concrete component is reduced.

Another preferred embodiment of the smoothing device comprises a secondary cutting edge for cutting through the concrete layer separated from the structural concrete component on a separation side facing away from the smoothing surface, in particular of the smoothing device.

The concrete layer is separated by means of the primary cutting edge. After the concrete layer has been cut off, it rests on the smoothing device. If the structural concrete component is sufficiently tough, the separated concrete layer remains integral and thus impedes further processing. By means of the secondary cutting edge, the concrete layer is cut through so that, in particular, successive concrete layer sections are generated and disposed of by the rotary movement of the smoothing device. The secondary cutting edge thus enables a uniform process that has fewer random error influences.

It is preferred that the secondary cutting edge has a greater distance from the smoothing surface in the direction of the axis of rotation than the primary cutting edge. This ensures that the concrete layer is cut through by the secondary cutting edge with a high degree of process reliability after separation. A main extension direction of the secondary cutting edge is preferably oriented orthogonally to the axis of rotation and/or orthogonally to the main extension direction of the primary cutting edge.

A preferred further embodiment of the smoothing device comprises a wing-shaped cutting body arranged on a side of the smoothing body facing away from the smoothing surface and having the secondary cutting edge. The wing-shaped cutting body may form the secondary cutting edge. A two- or more-winged cutting body advantageously generates the secondary cutting edge along a circumference of the smoothing device so that the separated concrete layer is cut through at uniform time intervals.

In particular, it is preferred that the smoothing body is annularly configured and the cutting body is wing-shaped.

A further preferred embodiment of the smoothing device is characterized by the fact that the smoothing body has the smoothing surface, the primary cutting edge and the secondary cutting edge. A smoothing body configured in such a way enables a simple construction of the smoothing device. It is particularly preferred that the smoothing body is configured in the shape of a wing. In such a smoothing body, the primary cutting edge preferably has a wing-shaped contour, since this is arranged in particular along an outer circumference of the wing-shaped smoothing body. Furthermore, it is preferred that the smoothing body is configured as a single piece.

A further preferred further embodiment of the smoothing device is characterized in that the smoothing body is configured such that the smoothing surface is replaceable. For example, the trowel body may comprise an interchangeable trowel unit comprising the trowel surface and/or the primary cutting edge(s).

In another preferred embodiment of the smoothing device, it is provided that the wing-shaped smoothing body comprises four wing elements each having a primary cutting edge, two first wing elements extend in a first wing direction and two second wing elements extend in a second wing direction orthogonal to the first wing direction.

Such a four-wing configured smoothing device has surprisingly led to advantageously configured structural concrete components. In particular, the surface finish has been further improved.

It is further preferred that the secondary cutting edges of the first blade elements are arranged along a first cutting line and/or the secondary cutting edges of the second blade elements are arranged along a second cutting line. With such arranged secondary cutting edges, a homogeneous process can be set up.

It is further preferred that the first cutting line and the second cutting line are oriented orthogonally to each other and/or each orthogonally to the axis of rotation.

This arrangement results in a uniform process during operation of the smoothing device.

It is further preferred that the smoothing device includes a receiving pin arranged coaxially with respect to the axis of rotation. The receiving pin can be used, for example, for coupling with a handling unit, for example a robot. The receiving journal preferably has a fluid guide for supplying a lubricant. This feed is preferably fluidically coupled to the lubricant feed.

A further preferred embodiment of the smoothing device comprises a clearance surface arranged on the separation side, in particular of the smoothing device, wherein preferably the clearance surface is configured by the smoothing body and/or by the cutting body. It is preferred that the secondary cutting edge is arranged adjacent to the free surface such that material located on the free surface reaches the secondary cutting edge by a rotation and a movement of the smoothing device in a feed direction. Advantageously, the concrete layer can be fed to the secondary cutting edge through the clearance surface, so that the concrete layer can be advantageously cut by the secondary cutting edge.

According to a further aspect, the above-mentioned task is solved by a smoothing system for smoothing a structural concrete component, comprising a smoothing device according to one of the embodiments described in the foregoing and a handling device, in particular a robot, for example a jointed-arm robot, for rotationally and/or translationally moving the smoothing device, the smoothing device being mechanically coupled to the handling device.

The handling device is preferably arranged to rotationally drive and/or move the smoothing device about the axis of rotation. The handling device preferably comprises a drive, in particular a driven spindle, for rotationally driving the smoothing device. Furthermore, the handling device is preferably arranged to supply lubricant to the smoothing device.

Furthermore, it is preferred that the smoothing system comprises two or more smoothing devices to meet different processing requirements. The handling device preferably has a frequency-controlled spindle in order to be able to adapt the speed to a specific machining task. For example, high speeds are set for high material removal rates and low speeds for high surface qualities. Preferably, the spindle has a rotary union through which the lubricant can be fed to the smoothing device via internal fluid channels. Furthermore, it is preferred that the handling device comprises a force torque sensor system, which can be used to guide the smoothing device in a force-controlled manner.

According to a further aspect, the task mentioned at the outset is solved by a method for smoothing a structural concrete component, in particular an uncured structural concrete component, in particular an additively produced structural concrete component, preferably a structural concrete component produced using a shotcrete method, comprising the steps: Separating a concrete layer from the structural concrete component, in particular with a smoothing device according to one of the embodiments described in the preceding, and time-parallel smoothing of a cut surface configured by the separation on the structural concrete component, in particular with a smoothing device according to one of the embodiments described in the preceding.

In a preferred embodiment of the method, this comprises the step of: dividing, in particular cutting, the separated concrete layer with a secondary cutting edge.

Furthermore, it is preferred that the method comprises the step of: Detaching and/or pressing in aggregates protruding from the cut surface.

It is further preferred that the cutting and/or smoothing is first performed starting from a first edge of the structural concrete component with a first feed direction, wherein this cutting and/or smoothing is interrupted before a second edge of the structural concrete component arranged opposite the first edge, and subsequently, starting from the second edge, the cutting and smoothing is continued with a second feed movement directed opposite the first feed direction. It is preferred that the surface thus produced is subsequently smoothed again.

In a further preferred embodiment of the method, it is provided that the structural concrete component comprises edges, lateral vertically oriented surfaces and an upper horizontal surface, comprising the steps of: angularly cutting and smoothing the edges of the structural concrete component, cutting and smoothing the lateral surfaces, cutting and smoothing the upper surface and smoothing the edges, the steps being performed in this order. Surprisingly, it has been shown that a high-quality structural concrete component can be produced with such a sequence.

A further preferred embodiment of the method comprises the step of: infeed and first re-smoothing and subsequent second re-smoothing substantially without infeed. The infeed relates in particular to the infeed of a smoothing device towards the structural concrete component. Furthermore, it is preferred that the edges are cut at an angle to surfaces forming the edges.

A further preferred further embodiment of the method is characterized in that first the edges are cut, then the concrete layer is cut off at vertically aligned, lateral surfaces and the cut surface is smoothed, then the concrete layer is cut off at a horizontally aligned, upper surface and the cut surface is smoothed, and then the edges are smoothed. Further, it may be preferred that the cut surface or surfaces be textured after smoothing. For example, a textured cut surface may have a broom finish geometry or a wood texture geometry.

A further preferred embodiment of the method is characterized in that the smoothing is force-torque controlled. Further, lubricant may be applied to the cut surface before and/or during smoothing. Furthermore, it is preferred that the smoothing is carried out with a smoothing device, in particular a smoothing device according to one of the embodiments described in the foregoing, wherein a rotational speed of the smoothing device is varied.

For further advantages, embodiment variants and embodiment details of the further aspects and their possible further embodiments, reference is also made to the previously given description regarding the corresponding features and further embodiments of the smoothing device.

Preferred embodiments are explained by way of example with reference to the accompanying figures. They show:

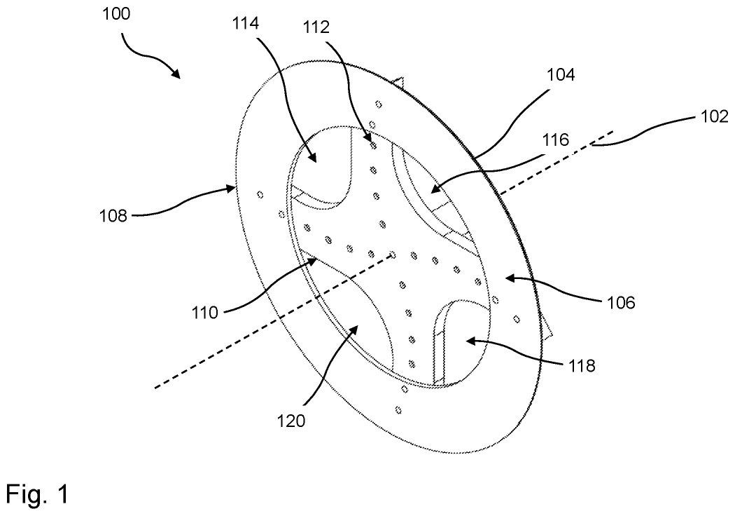

FIG. 1: a schematic, three-dimensional view of an exemplary embodiment of a smoothing device;

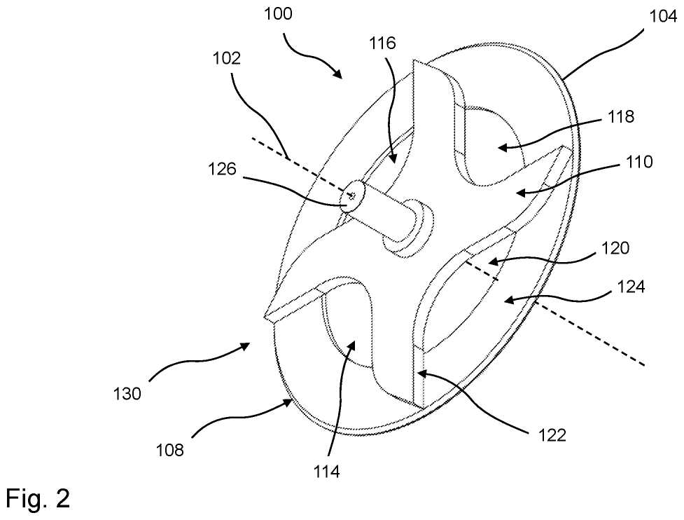

FIG. 2: a schematic, three-dimensional view of the smoothing device shown in FIG. 1;

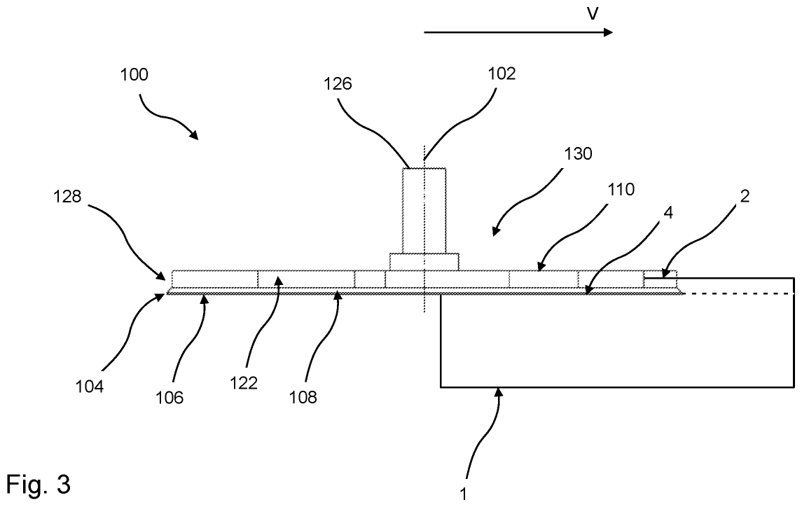

FIG. 3: a schematic, two-dimensional view of the smoothing device shown in FIG. 1;

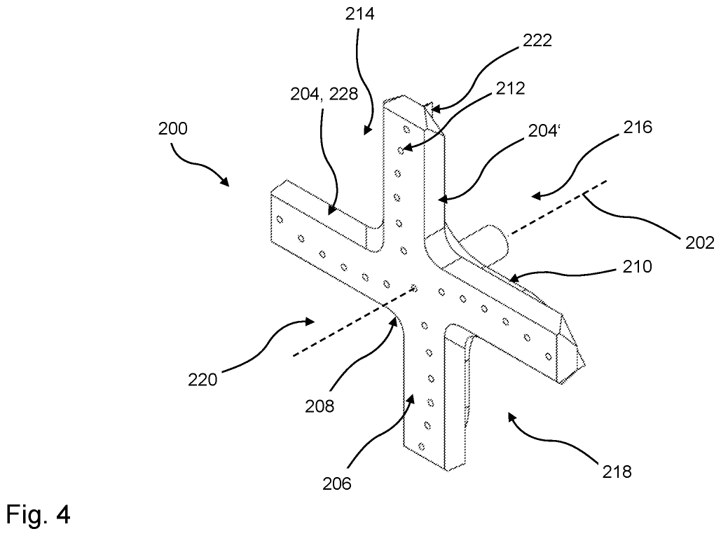

FIG. 4: a schematic, three-dimensional view of a further exemplary embodiment of a smoothing device;

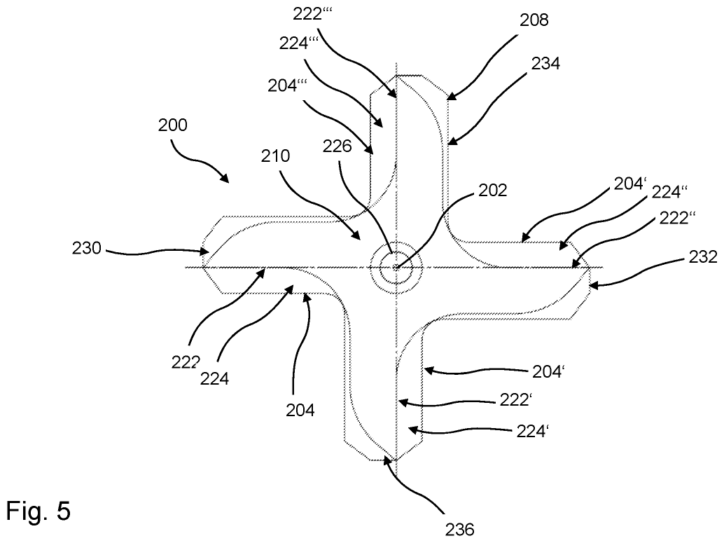

FIG. 5: a schematic, two-dimensional view of the smoothing device shown in FIG. 4;

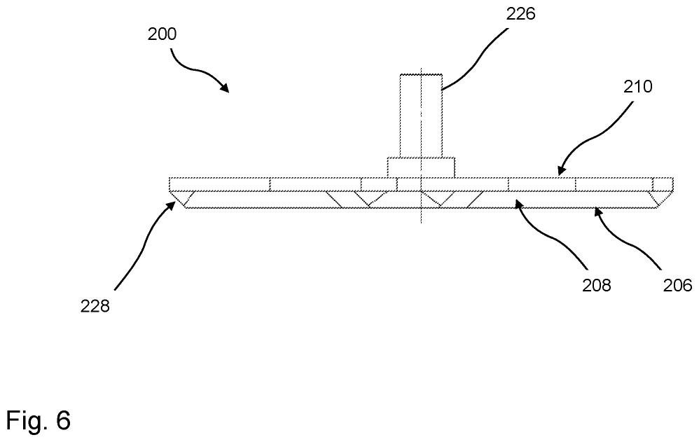

FIG. 6: a schematic, two-dimensional view of the smoothing device shown in FIG. 4;

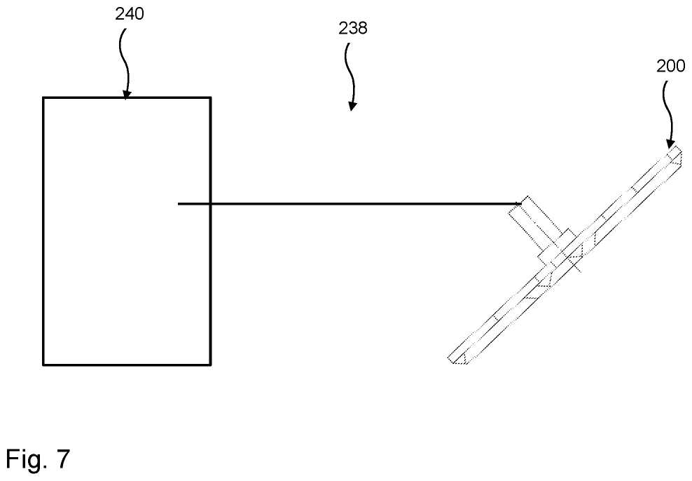

FIG. 7: a schematic two-dimensional view of an exemplary embodiment of a smoothing system; and

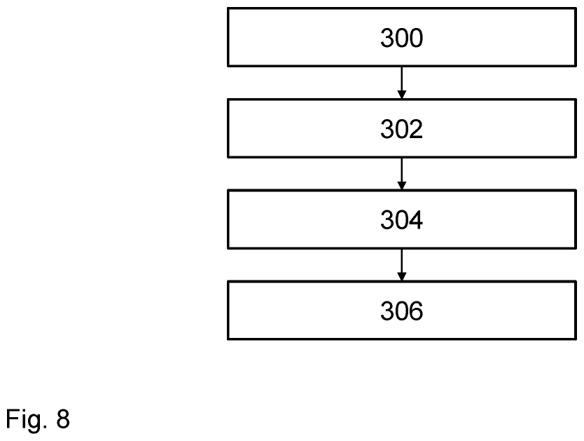

FIG. 8: a schematic method.

In the figures, identical or essentially functionally identical or similar elements are designated by the same reference signs.

The smoothing device 100 shown in FIGS. 1-3 has an axis of rotation 102 about which the smoothing device 100 is configured to be substantially rotationally symmetrical. The smoothing device 100 further comprises an annular smoothing body 108 having a primary cutting edge 104 configured on the outer periphery thereof. Furthermore, the smoothing body 108 generates the smoothing surface 106 which, in operation of the smoothing device 100, contacts a cutting surface 4 in a planar manner. In particular, in FIG. 2, the cutting body 110 of the smoothing device 100 is shown forming the secondary cutting edge 122. The cutting body 110 is configured in the shape of a wing. By arranging the cutting body 110 configured in such a manner on the smoothing body 108, the disposal sections 114-120 are formed.

Furthermore, the smoothing body 108 generates clearance areas 124 between the wings of the cutting body 110. From the clearance surfaces 124, the separated concrete layer is guided to the secondary cutting edges 122, where it is separated. Further, the smoothing device 100 includes a receiving pin 126 for coupling to a handling device.

In FIG. 3, the smoothing device 100 is further shown in operation. The smoothing device 100 is guided through a structural concrete component 1 in the feed direction V such that a concrete layer 2 is separated, so that a cut surface 4 is configured on the structural concrete component. The cut surface 4, which has not yet been produced, is shown dashed. The concrete layer 2 is cut off by the primary cutting edge 104. The primary cutting edge 104 is configured by a front side portion of the front side 128 of the smoothing body 108. Immediately after separation, the separated concrete layer 2 is located on the separating side 130 of the smoothing device 100, where the concrete layer 2 is guided to the secondary cutting edges 122 and continuously separated therefrom, so that the concrete layer 2 is separated into individual pieces and can thus be discharged.

FIG. 4 shows a second embodiment of the smoothing device 200. The smoothing device 200 has a rotation axis 202 in an analogous manner. The smoothing body 208 of the smoothing device 200 has a smoothing surface 206. The smoothing body 208 further generates a total of four primary cutting edges 204, 204′, 204″, 204″. The primary cutting edges 204, 204′, 204″, 204′″ are arranged on the two first blade elements 230, 232 and the two second blade elements 234, 236.

Furthermore, it can be seen from FIG. 5 that the wing elements 230-236 have a total of four secondary cutting edges 222, 222′, 222′, 222″. Furthermore, the clearance surfaces 224, 224′, 224″, 224″ are provided on the wing elements 230-236. The smoothing body 208 and the cutting body 210 are integrally configured. A lubricant supply 212 is further arranged on the receiving journal 226.

The disposal sections 214-220 are configured by the geometry of the smoothing device 200. The face 228 of the smoothing device 200 shown in FIG. 6 is configured such that aggregate projecting from the cutting surface 4 is forced into the cutting surface 4. A surface orthogonal of the face 228 includes an angle of <90° starting from the smoothing surface 206 with the rotation axis 202.

In FIG. 7, a smoothing system 238 is shown which comprises a smoothing device 200 and a handling device 240, wherein the smoothing device 200 is mechanically coupled to the handling device 240, in particular such that the smoothing device 200 is rotationally driven about the axis of rotation 202 by the handling device 240.

FIG. 8 shows a schematic method. In step 300, a concrete layer 2 is separated from the structural concrete component 1 with a primary cutting edge 104, 204, 204′, 204″. Step 302 takes place substantially in parallel time with step 300, in which a cut surface 4 on the structural concrete component 1 configured by the separation is smoothed in parallel time with a smoothing surface 106, 206. In step 304, the separated concrete layer 2 is cut, in particular cut, with a secondary cutting edge 122, 222, 222′, 222″. Parallel in time to this, aggregate particles protruding from the cut surface 4 are furthermore dislodged or pressed in.

With the smoothing device 100, 200 described in the foregoing, a structural concrete component 1 can be produced in an advantageous manner. In particular, this can be produced with a high surface quality, since a surprisingly good surface can be produced with the smoothing device 100, 102 by the combination of a layer removal and a smoothing. The integral combination of a smoothing surface 106, 206 with a primary cutting edge 104, 204, 204′, 204″ and a secondary cutting edge 122, 222, 222′, 222″ provides a homogeneous process for producing high surface finishes.

### REFERENCE SIGNS

1 structural concrete component
2 concrete layer
4 cutting surface
100 smoothing device
102 rotary axis
104 primary cutting edge
106 smoothing surface
108 smoothing body
110 cutter body
112 lubricant inlet
114 disposal section
116 disposal section
118 disposal section
120 disposal section
122 secondary cutting edge
124 open area
126 locating journal
128 front side
130 cutting side
200 smoothing device
202 rotation axis
204, 204′ primary cutting edge
204″, 204′″ primary cutting edge
206 smoothing surface
208 smoothing body
210 cutter body
212 lubricant inlet
214 disposal section
216 disposal section
218 disposal section
220 disposal section
222, 222′ secondary cutting edge
222′, 222′″ secondary cutting edge
224, 224′ clearance section
224″, 224′″ clearance section
226 locating journal
228 end face
230, 232 first wing elements
234, 236 second wing elements
238 smoothing system
240 handling device
V feed direction

1. A smoothing device for smoothing an uncured structural concrete component, comprising
a primary cutting edge for separating a concrete layer from the structural concrete component,
an axis of rotation, and
a smoothing surface aligned orthogonally to the axis of rotation for surface contacting of a cut surface of the structural concrete component formed by the separation.

2. Smoothing device according to claim 1, wherein the smoothing surface and the primary cutting edge are arranged and configured such that in a feed direction first the primary cutting edge, cuts off the concrete layer and subsequently the smoothing surface contacts the cut surface.

3. Smoothing device according to claim 1, wherein the smoothing surface and the primary cutting edge are arranged on a smoothing body, wherein the smoothing body is configured in the shape of a circular ring and/or a wing.

4. Smoothing device according to claim 3, wherein the primary cutting edge is configured on a front side of the smoothing body, and is configured by an inclination of the front side and/or of a front side section of the front side with respect to the axis of rotation.

5. Smoothing device according to claim 1, wherein the primary cutting edge is spaced from the smoothing surface in the direction of the axis of rotation.

6. Smoothing device according to claim 1, comprising a disposal section configured as a chip flute, which is arranged at least in sections between the primary cutting edge and the axis of rotation.

7. Smoothing device according to claim 1, comprising at least one lubricant feeder for feeding a lubricant to the smoothing surface.

8. Smoothing device according to claim 1, comprising a secondary cutting edge for cutting through the concrete layer separated from the structural concrete component on a separation side facing away from the smoothing surface, wherein the secondary cutting edge has a greater spacing from the smoothing surface in the direction of the axis of rotation than the primary cutting edge.

9. Smoothing device according to claim 1, comprising a wing-shaped cutting body arranged on a side of a smoothing body facing away from the smoothing surface and having a secondary cutting edge.

10. Smoothing device according to claim 1, wherein
a smoothing body comprises the smoothing surface, the primary cutting edge and a secondary cutting edge;
the smoothing body is configured in the shape of a wing, and/or
the smoothing body is configured in an integral manner.

11. Smoothing device according to claim 1, wherein
a wing-shaped smoothing body comprises four wing elements each having a primary cutting edge,
two primary blade elements extend in a first blade direction and two secondary blade elements extend in a second blade direction which is orthogonal to the first blade direction,
secondary cutting edges of first wing elements are arranged along a first cutting line and/or the secondary cutting edges of second wing elements are arranged along a second cutting line, and
the first cutting line and the second cutting line are oriented orthogonally to each other and/or each orthogonally to the axis of rotation.

12. Smoothing device according to claim 1, comprising a clearance surface arranged on a separation side facing away from the smoothing surface, the clearance surface being configured by a smoothing body and/or by a cutting body.

13. Smoothing system for smoothing a structural concrete component, comprising
a smoothing device according to claim 1, and
a robotic handling device for moving the smoothing device rotationally and/or translationally,
wherein the smoothing device is mechanically coupled to the handling device.

14. Method for smoothing an uncured structural concrete component, comprising the steps:
Separating a concrete layer from the structural concrete component using the smoothing device according to claim 1, and
Smoothing a cut surface formed by the separation on the structural concrete component with the smoothing device.

15. Method according to claim 14, wherein the smoothing is performed simultaneously with the separating.

16. Method according to claim 14, comprising the step:
Cutting the separated concrete layer with a secondary cutting blade.

17. Method according to claim 16, wherein the cutting and/or smoothing is first performed starting from a first edge of the structural concrete component with a first feed direction, wherein this cutting and/or smoothing is interrupted before a second edge of the structural concrete component arranged opposite the first edge, and subsequently, starting from the second edge, the cutting and/or smoothing is continued with a second feed movement directed opposite the first feed direction.

18. Method according to claim 14, comprising the step of: Infeed and first post-smoothing and subsequent second post-smoothing substantially without infeed.

19. Method according to claim 14, wherein edges are cut angled to surfaces forming the edges.

20. Method according to claim 14, wherein first edges are cut, subsequently on vertically aligned lateral surfaces the concrete layer is cut off and the cut surface is smoothed, subsequently on a horizontally aligned upper surface the concrete layer is cut off and the cut surface is smoothed, and subsequently the edges are smoothed.

21. Method according to claim 20, wherein the cut surface is textured after smoothing.

22. Method according to claim 14, wherein the smoothing is force-torque controlled.

23. Method according to claim 14, wherein lubricant is applied to the cut surface before and/or during smoothing.

24. Method according to claim 14, wherein the smoothing is carried out with the smoothing device, wherein a speed of the smoothing device is varied.
